(19) United States
(12) Patent Application Publication
(10) Pub. No.: US 2012/0270436 A1
(43) Pub. Date: Oct. 25, 2012

(54) IDENTIFYING INDIVIDUAL COPPER NETWORK CABLES ON A PATCH PANEL

(76) Inventor: Stephen P. Blythe, Tiverton, RI (US)

(21) Appl. No.: 13/449,574

(22) Filed: Apr. 18, 2012

Related U.S. Application Data
(60) Provisional application No. 61/476,954, filed on Apr. 19, 2011.

(51) Int. Cl. H01R 3/00

(52) U.S. Cl. 439/490

(57) ABSTRACT

Cables of large scale network installation are efficiently identified for labeling or verification or correct connection in relation to the patch panel of a distribution frame by providing transmitter at each remote cable end to be tested and light identification devices (LIDs) as plugs at patch panel ports, the transmitter providing closed circuit activation at a patch panel end to light up a LID plug at the patch panel port end of the cable.

The present application claims priority from U.S. application Ser. No. 61/476,954 filed Apr. 19, 2011. The present invention relates to the installation of network cables.

### FIELD AND BACKGROUND OF THE INVENTION

When installing network cables in a structured wiring environment for a local area data or voice signal network, the process of identifying each cable and labeling correctly which is required by industry standards is often times more time consuming than the actual labor involved in pulling the cable. A cabled network consists of main and/or isolated distribution frames (MDF/IDF) where network cables are terminated on patch panels. These cables are generally run from jacks on a patch panel or a 110 style connecting block at the distribution frame and terminate in remote locations at individual workstations or plug-in jacks of industry standard form, e.g. RJ45. When sometimes hundreds and thousands of these cables are needed for a network, tracing out each one correctly is a complex labor-intensive task.

Currently, the standard method for identifying each cable involves two workers using a tone set and inductive speaker. A first worker is stationed at the remote jack or work station that requires identification and labeling to correspond identically with the termination location at the distribution frame. He or she plugs a tone/signal generator into the remote jack or work station connection to cabling which creates an audio signal that is transmitted down the cable. A second worker, stationed at the frame, then scans each termination port on each patch panel until the signal is found by tone recognition and the cable thus is identified. This process is repeated over and over again until each cable in the system is identified.

This process is extremely time consuming and prone to error as the signal sometimes “bleeds” from one cable to another resulting in a wrong identification or ambiguity and delay.

### SUMMARY OF THE INVENTION

The present invention provides an apparatus and method to enhance the process of cable verification and labeling which comprises use of two component parts or part sets and a procedure for operating them. The first component is a set of multipurpose plugs with internal conductive paths that can be inserted into a patch panel or connected to a 110 style termination block, each plug having an added light indicator, such as an LED connected across two such internal conductive paths. One each of these plugs is inserted into jacks of the panel.

The second component is a transmitter system comprising one or more probe plugs with power supplies which can contact signal contact points of a remote jack, socket or work station. One worker applies the second component to two contacts of the jack, socket or workstation that are tied to a cable remote end and a second worker at the patch panel observes which visual indicator on one of the plugs at the panel lights up in response. The first and second components are set to contact the same wires in a cable to make a complete circuit through the cable. and that usage process is repetitively done working sequentially through all remote cable ends to be tested. The end result can be proper labeling of each cable at one or both ends and/or in between or simply assuring that a valid intended connection has been made for each cable apart from any labeling or other coding.

Other objects, features and advantages will be apparent from the following detailed description of preferred embodiments taken in conjunction with the accompanying drawings in which:

### BRIEF DESCRIPTION OF THE DRAWINGS

FIGS. 1A, 1B show schematically two versions of transmitters with a small portable power source that a worker can connect into the remote location network jack that needs to be identified in relation to a patch panel;

FIGS. 2A and 2B and 2C show, schematically, three versions of a dual color, polarity sensitive, Lighted Identification Device (LID) plug; and consisting of a modular plug fitted with a light emitting diode; and

FIGS. 3 and 4 are a photographs of a patch panel apparatus with dozens of such LID plugs inserted temporarily into most or all of its termination ports.

### BRIEF DESCRIPTION OF PREFERRED EMBODIMENTS

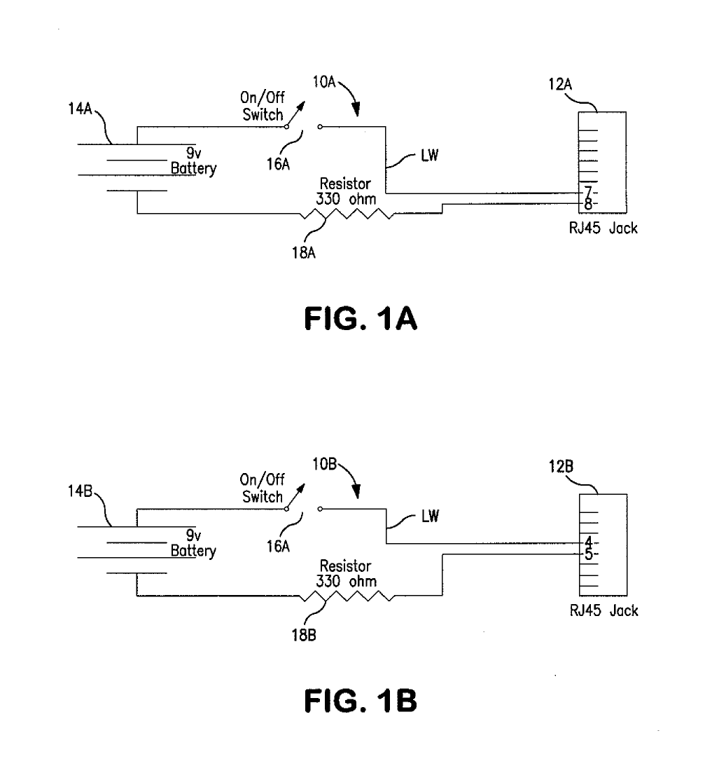

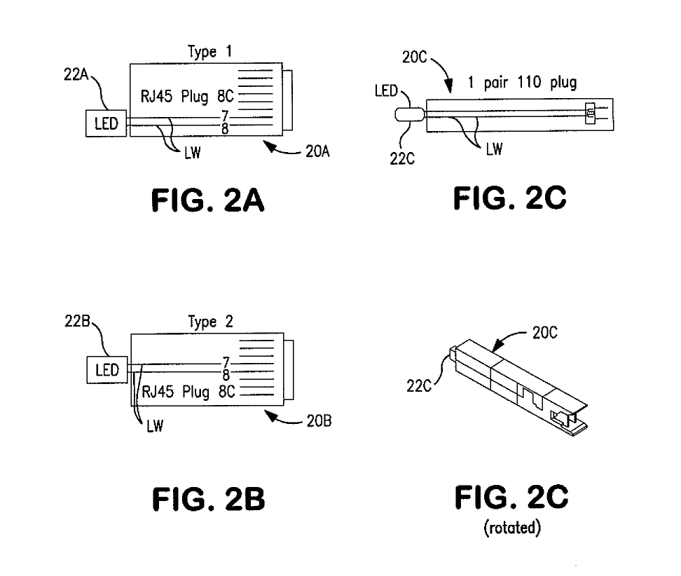

Preferably the system and method of the invention identifies or verifies each cable quickly using two workers and these components. The transmitters 10A, 10B of FIGS. 1A, 1B comprise R.145 jacks 12A, 12B, each having eight parallel internal conductive paths, a power supply 14A, 1413 (which can be a battery, fuel cell, rectified a.c, supply or other means, typically providing 9 volts direct current), switching means 16A, 16B (diverse types are usable) and a voltage drop means 18A, 18B (typically a 330 ohm resistor). Proper voltage polarity is required to correspond with the polarity of the LID in order for correct illumination to occur. Long lead wires LW are provided that are inserted into the jack at conductors 7, 8 of jack 12A or conductors 4, 5 or jack 12B. LIDs of 20A or 20B of FIGS. 2A, 2B are provided as R.145/8C plugs with eight parallel internal conductive paths and a small light source 22A, 22B, e.g. a light emitting diode (LED) with long lead wires LW is provided that are inserted at conductors 7, 8 of plug 20A of FIG. 2A and conductors 4, 5 of FIG. 2B. LIDs of 20C of FIG. 2C are provided as 110/2C plugs with two parallel internal conductive paths and a small light source 22C, e.g., a dual color polarity sensitive light emitting diode (LED) with long lead wires L W is provided that are inserted at conductors 7, 8 of plug 20C of FIG. 2C. Other hardware of similar functional attributes can be substituted for items 20A, 10B, 22A, 22B, 22C to test a variety of wiring systems. Proper voltage polarity is required, in the transmitter power source, to correspond with the polarity of the LID in order for correct illumination to occur.

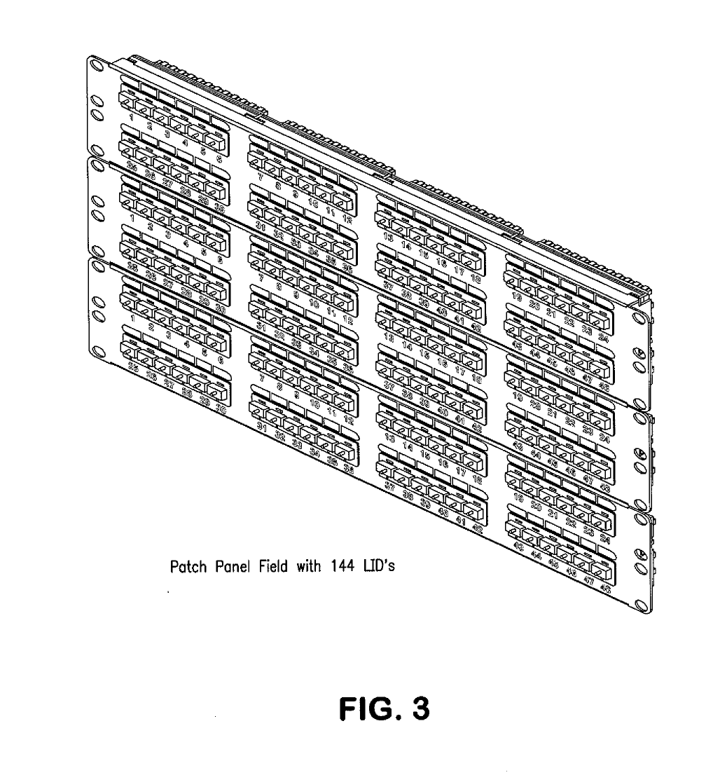

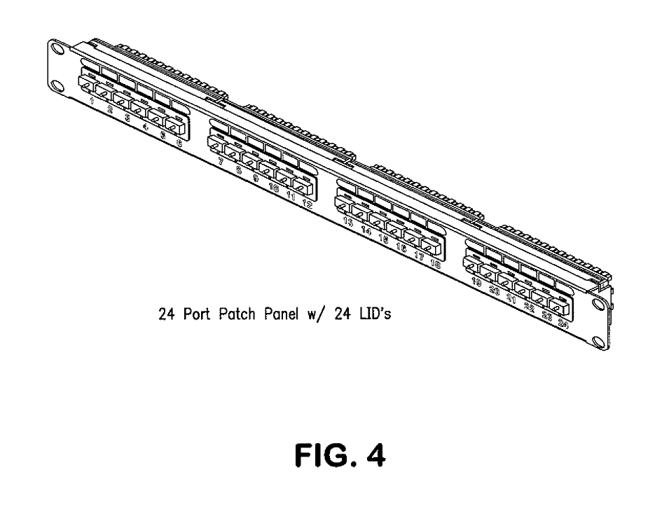

A first worker can plug a LID 20A or 20B into each of the patch panel ports at the MDF. In the demonstration in FIGS. 3-4, 148 LID's are temporarily plugged into the termination ports on the patch panel. The second worker would use the transmitter 10A or 10B at each of the remote jack locations that requires identification for labeling or verification and plug it into the jack or other live connection at that location. At the very instant that the transmitter is connected to the jack, the LID that is plugged into the patch panel at the other end of the cable from the remote location will illuminate giving the first worker who is at the panel a visual identification of the cable being traced as demonstrated. The color illumination of the dual color, polarity sensitive LED located within the LID is vital to the device and process. Green will indicate proper polarity termination at each end point and throughout the cable. A red illumination will indicate a polarity reversal at one termination end or in the cable and will indicate need for further testing and repair. Without this polarity sensitive circuit and color indication, the user would receive no lighted indication of the circuit and therefore resort to other testing means to identify the cable in question. As each cable is identified, the corresponding plug can be removed from the patch panel since the worker knows that port has already been identified. This procedure is repeated until all cables are visually identified and communicated to the worker applying test voltage at the jack for proper labeling.

Other variants of the system and method are available. For instance, jacks can be inserted in all the patch panel ports instead of a few jacks being used sequentially to verify correct or incorrect connection at each port or group of ports. Automated visualizing and signaling equipment can be provided at the patch panel to enable a part time worker or eliminate a worker there. A single worker can do the remote cable and probing and call back on the patch panel. These alternatives may be suitable under circumstances of some projects.

This device is portable and independent regardless of location. It works with all standards and manufacturers jacks, cables and patch panels.

The invention has been tested for wire identification/verification in several large scale installations and reduced job timing, manpower usage by 30-40% compared to customary practice without the invention. The savings of one or two usages can pay back the cost of the apparatus.

It will now be apparent to those skilled in the art that other embodiments, improvements, details, and uses can be made consistent with the letter and spirit of the foregoing disclosure and within the scope of this patent, which is limited only by the following claims. construed in accordance with the patent law, including the doctrine of equivalents.

What is claimed is:

1. Apparatus for verifying a valid connection of cables of a network to a common distribution frame patch panel with multiple ports, each corresponding to a panel end of one of the cables (or cable groups) comprising:
(a) means for providing a voltage at the remote end of each cable,
(b) means for providing an illuminable device at a panel port,
whereby a closed circuit is formed through the cable and the device illuminated if the cable connection has a means (a) and (b) at its respective remote and panel port ends.

2. The apparatus of claim 1 wherein the means (a) and (b) comprise lead wires inserted into plugs or jacks.

3. The apparatus of claim 1 constructed and arranged for correct polarity verification.
